(19) United States
(12) Patent Application Publication
(10) Pub. No.: US 2011/0248157 A1
(43) Pub. Date: Oct. 13, 2011

(54) MASS SPECTROMETER AND MASS SPECTROMETRY METHOD

(76) Inventors: Masuyuki Sugiyama, Hino (JP); Yuichiro Hashimoto, Tachikawa (JP); Hideki Hasegawa, Tachikawa (JP); Masuyoshi Yamada, Ichikawa (JP); Hiroyuki Yasuda, Hitachinaka (JP); Shinji Nagai, Hitachinaka (JP); Shintaro Kubo, Hitachinaka (JP); Takefumi Yokokura, Kasama (JP)

(21) Appl. No.: 13/123,901

(22) PCT Filed: Oct. 13, 2009
(86) PCT No.: PCT/JP2009/005320

§ 371 Date: Jun. 29, 2011

(30) Foreign Application Priority Data
Oct. 14, 2008 (JP) 2008-264750
Jan. 27, 2009 (JP) 2009-014871

(51) Int. Cl. H01J 49/42

(52) U.S. Cl. 250/282; 250/288

(57) ABSTRACT

Objects of the present invention is to provide a quadrupole mass filter that can be fabricated at low cost and has a high transmission efficiency even under a high pressure (0.5 mTorr or more), and to provide a mass spectrometer or mass spectrometry method that reduces crosstalk in a wide mass range. Now, in a mass spectrometer, an ion separating unit is configured to include quadrupole rod electrodes that form a quadrupole radio-frequency electric field, electrodes that form a quadrupole electrostatic field, and a power supply that allows the voltage of the electrodes to form a quadrupole electrostatic field to change. In a collision cell configured to perform collision induced dissociation, harmonic potentials in a plurality of stages are produced to resonance excite ions in the axial direction, so that the ions obtain kinetic energy to move in the direction of the detector. This energy allows a time period to shorten for which ions stay in the collision cell.

### TECHNICAL FIELD

The present invention relates to a mass spectrometer and a mass spectrometry method.

### BACKGROUND ART

Mass spectrometers are devices in which electric charges are added to sample molecules for ionization, the generated ions are separated according to their mass-to-charge ratios using an electric field or magnetic field, and the amount is measured as current values by a detector. The mass spectrometer is highly sensitive, and excellent in quantitative determination and identification capabilities as compared with conventional analyzers. In recent years, in the field of life science, attention has been focused on peptide analysis or metabolite analysis instead of genome analysis, and the effectiveness of the mass spectrometer has been reevaluated, which is highly sensitive and excellent in identification and quantitative determination capabilities.

A quadrupole mass filter in the above-mentioned mass spectrometer is well-known mass spectrometry, which is widely used because of its simple operation. For an example of the quadrupole mass filter, Patent Document 1 is described. In the quadrupole mass filter, a quadrupole radio-frequency (RF) field is combined with a quadrupole electrostatic field in a suitable strength, and only ions with a specific mass-to-charge ratio (m/z) are allowed to selectively pass. The interaction between the quadrupole RF field and the electrostatic field causes a fringing field (fringing field) at the inlet end and outlet end of the quadrupole mass filter. When a fringing field is produced at the inlet end of the quadrupole mass filter, at which ions enter, the ion transmission efficiency of the quadrupole mass filter is greatly reduced. Patent Document 2 describes a method in which a short quadrupole electrode (Brubaker lens) applied with only a quadrupole RF voltage is inserted before a quadrupole mass filter, avoiding the influence of a fringing field and improving ion transmission efficiency.

In the quadrupole mass filter or quadrupole ion guide, because the force of accelerating ions does not work in the axial direction, the kinetic energy of ions in the axial direction is cooled due to the collision against neutral molecules and the ions come to a stop thereinside under a high pressure. Because of this, it takes about a few to few tens ms for ions to pass the quadrupole ion guide at a pressure of about 5 mTorr. When ions stay in the region to which a quadrupole electrostatic field is applied for a long time, even ions with m/z that can originally pass the quadrupole mass filter are removed, so that the ion transmission efficiency is decreased.

Patent Document 3 describes a method in which an electric potential gradient is formed on the center axis of a quadrupole ion guide for preventing ions from staying even under a high pressure. For specific methods of forming the electric potential gradient, described are methods of using a resistive rod electrode, inserting an electrode in a space between rod electrodes, tilting rod electrodes, etc. In addition, Patent Document 4 describes a method in which a quadrupole rod electrode made of a resistive element is used to form an electric potential gradient on the center axis of the quadrupole mass filter.

Now, some types of mass spectrometers are named based on the principles. For mass spectrometers mainly used nowadays, a quadrupole mass spectrometer (QMS: Quadrupole Mass Spectrometer) and a time-of-flight mass spectrometer (TOFMS: Time Of Flight Mass Spectrometer) are named.

The quadrupole mass spectrometer is a mass spectrometer in which a pole with four cylinders or hyperboloids is used for an electrode and a high frequency voltage and a direct current voltage are applied to perform mass separation. A high frequency alternating voltage is applied to form a quadrupole electric field between the electrodes for producing a quasi well potential to cause ions to focus between the electrodes. At this time, on superimposing a direct current voltage, ions with a specific mass-to-charge ratio are allowed to pass, and the ions are transported to a detector to measure the amount of the ions. On voltage-sweeping the direct current voltage and the alternating voltage at a voltage ratio at which only specific ions pass, ions reach a detector in the order of ions with lower mass-to-charge ratios for obtaining mass spectra. The quadrupole mass spectrometer has a feature of high quantitative determination performance because it allows sequential measurements and has a detector with a wide dynamic range.

The time-of-flight mass spectrometer accelerates ions with an electric field and measures a time period for which ions reach a detector for performing mass separation. Acceleration energy that is given to ions by an electric field is constant, so that the time period for which ions reach a detector varies depending on mass-to-charge ratios. Because of this, ions with a low mass-to-charge ratio reach the detector fast, whereas ions with a high mass-to-charge ratio reach it slowly. When the current value outputted from the detector is plotted on the arrival time to make a graph, a mass spectrum can be obtained. The time-of-flight mass spectrometer has a feature of high qualitative performance because it has high mass resolution and high mass accuracy.

The mass spectrum obtained by the two above-mentioned mass spectrometers is different depending on the mass of a sample to measure, pieces of information on the component or amount of the sample can be obtained from the mass spectrum. However, constituents in the sample are sometimes complicated, or the obtained mass spectrum sometimes has information insufficient for identifying a component. More particularly, because the mass spectrometer identifies a molecule ion by a mass-to-charge ratio, it becomes difficult to distinguish between molecule ions if mass-to-charge ratios are the same or if the resolution of the mass spectrometer is poor even though ions have different structures. In addition, in a mass spectrum in which a mass-to-charge ratio is 400 or less, it is impossible to distinguish a target component from impurities because there are many impurities in a solvent or impurities derived from an environment. Thus, in order to address the problems, MSⁿ analysis is conceived.

MSⁿ analysis is a method in which molecule ions are captured into a mass spectrometer, molecule ions with a specific mass-to-charge ratio are selected, and the collision of the selected molecule ions against neutral molecules is caused to partially dissociate the bonding between the molecule ions to measure ions with broken bonding. Breaking the bonding of molecule ions by colliding the molecule ions against neutral molecules is called collision induced dissociation (CID: Collision Induced Dissociation), and MS², MS³ or the like is called depending on the repeat counts of a sequence of operations of ion selection and collision induced dissociation. Because the bonding between atoms in a molecule has different bonding energy depending on its structure or bonding type, bonding is more broken at places with lower bonding energy by collision induced dissociation. In collision of molecule ions against neutral molecules, kinetic energy sufficient to break bonding is given to the molecule ions to produce fragment ions unique to the molecule, allowing the structure of the molecule ions to be found. Moreover, ions are selected and cleaved, so that noise is small in the mass-to-charge ratio region of the ions after cleaved and the ratio of signal intensity to noise (signal-to-noise ratio) is improved.

A mass spectrometer that performs mass separation after ion selection and collision induced dissociation are performed one time or more is generally referred to as a tandem MS. For devices capable of performing ion selection and collision induced dissociation one time, a quadrupole time-of-flight mass spectrometer (Q-TOF) and a triple quadrupole mass spectrometer (Triple QMS) are named.

The quadrupole time-of-flight mass spectrometer is a device that a quadrupole mass spectrometer is combined with a time-of-flight mass spectrometer and a collision cell is provided in between for performing MS/MS (or also referred to asMS²). The collision cell is a chamber in which neutral molecules such as helium or nitrogen are introduced into thereinside and the internal pressure is increased to raise the collision probability of ions against the neutral molecules for performing collision induced dissociation. After selecting target ions for MS/MS from a sample in the quadrupole mass spectrometer, the energy introduced into the collision cell causes ion to cleave. The cleaved ions are subjected to mass separation in the time-of-flight mass spectrometer provided in the subsequent stage, and then an MS/MS mass spectrum can be obtained. Because the time-of-flight mass spectrometer is used for a mass separating unit, an MS/MS spectrum of high resolution and high mass accuracy can be acquired, and highly reliable results can be obtained. Because of this, it is a device that is often used for identification analysis such as protein analysis.

The triple quadrupole mass spectrometer is a device that three quadrupole mass spectrometers are combined and the quadrupole mass spectrometer in between is a collision cell. The configuration of the collision cell and the principle of collision induced dissociation are the same as those of the foregoing quadrupole time-of-flight mass spectrometer, in which ions are selected at the quadrupole mass spectrometer in the first stage, ions are cleaved in the second stage, and mass separation is performed in the third stage. The triple quadrupole mass spectrometer is a quadrupole mass spectrometer having a mass separating unit different from that of the quadrupole time-of-flight mass spectrometer, so that it can obtain results of high quantitative determination. For this reason, it is a device that is often used for quantitative analysis such as pharmacokinetics analysis. For related art documents, there is Patent Document 5, for example.

### RELATED ART DOCUMENTS

### Patent Documents

Patent Document 1: U.S. Pat. No. 2,950,389
Patent Document 2: U.S. Pat. No. 3,129,327
Patent Document 3: U.S. Pat. No. 5,847,386
Patent Document 4: U.S. Pat. No. 7,164,125
Patent Document 5: Japanese Patent Application Laid-Open Publication No. 2005-353304
Patent Document 6: Japanese Patent Application Laid-Open Publication No. 2007-95702

### SUMMARY OF THE INVENTION

### Problems that the Invention is to Solve

A first problem of the present invention is to provide a quadrupole mass filter that can be fabricated at low cost and has a high transmission efficiency even under a high pressure (0.5 mTorr or more).

The above-mentioned Patent Document 2 has no description concerning a method of preventing ions from staying. In addition, because a quadrupole rod used for a Brubaker lens is necessary other than the quadrupole rods of the quadrupole mass filter, there are drawbacks that fabrication costs are increased.

The above-mentioned Patent Document 3 describes only the method of forming an electric potential gradient on the center axis of the ions guide to which a quadrupole electrostatic field is not applied, and has no description concerning a method of forming an electric potential gradient on the center axis of the quadrupole mass filter to which a quadrupole electrostatic field is applied.

The above-mentioned Patent Document 4 describes only the method of forming an electric field on the center axis of the quadrupole mass filter by forming the quadrupole rod electrode of a resistive element, and has no description concerning a method of forming an electric field on the center axis by another method as by inserting an electrode between rods. There were drawbacks that it is technically difficult to form a highly accurate quadrupole rod electrode of a resistive element and that costs are increased as compared with the case of using a metal quadrupole rod electrode.

Moreover, in any methods in Patent documents 1, 2, and 4, there was a problem in that it is necessary to apply both of the quadrupole RF voltage and the quadrupole electrostatic voltage to the quadrupole rod electrode, causing a complicated power supply.

Furthermore, a second problem of the present invention is a problem in that the tandem MS has superiority as described above, but has a problem called crosstalk in performing collision induced dissociation. Crosstalk means that because a reduction in kinetic energy in collision causes a reduction in the ion velocity and an expansion in the velocity distribution, a previous result remains in a subsequent result when a plurality of kinds of samples (ions) are measured. Thus, unnecessary structural information is displayed, or a reduction in the accuracy of quantitative determination occurs.

In order to address this problem, a spectrometer with an axial field is disclosed (for example, see Patent Document 6). This spectrometer is a method of accelerating ions by forming a direct current voltage field in the axial direction. However, there is a problem in that the potential difference in the axial direction is small and the effect becomes smaller as the mass number is increased.

Now, a first object of the present invention is to provide a quadrupole mass filter that can be fabricated at low cost and has a high transmission efficiency even under a high pressure (0.5 mTorr or more).

In addition, a second object of the present invention is to provide a mass spectrometer or mass spectrometry method that reduces crosstalk in a wide mass range.

### Means for Solving the Problems

A feature of the present invention is a mass spectrometer in which an ion separating unit includes: quadrupole rod electrodes configured to form a quadrupole radio-frequency electric field; electrodes each inserted between the quadrupole rod electrodes, the electrodes being configured to form a quadrupole electrostatic field; and a voltage control unit configured to control at least a voltage of the electrodes to form a quadrupole electrostatic field. Here, an electric potential gradient is formed on the center axis of the quadrupole rod electrodes by the electrodes to form a quadrupole electrostatic field. Moreover, the strength is small on the inlet side of ions, whereas it is large on the exit side. The electrodes to form a quadrupole electrostatic field are a plate shaped electrode or rod shaped electrode inserted between the adjacent electrodes of the quadrupole rod electrode, for example.

Furthermore, another feature of the present invention is a mass spectrometer including: an ion source unit configured to ionize a sample; a first mass separating unit configured to selectively pass, trap, or eject target ions such as a quadruple field from the ions generated in the ion source; a collision cell configured to cause the target ions to collide against neutral molecules for subjecting the selected ions to collision induced dissociation; a second mass separating unit configured to allow ions to separate according to mass-to-charge ratios; and a detector configured to convert an amount of ions that reach the detector into a current value, in which a potential that causes ions to move in simple harmonic oscillation in the axial direction is formed in the inside of the collision cell, and energy is given to the ions in an axial direction due to resonant excitation.

In addition, still another feature of the present invention is to provide suitable axial energy in a wide mass-to-charge ratio range by freely changing the amplitude of an auxiliary alternating voltage for resonant excitation at a frequency with which ions resonate.

The foregoing features of the present invention and features other than the foregoing ones will be explained in more detail from the descriptions below.

### Effect of the Invention

According to the present invention, it is made possible to implement a quadrupole mass filter that has a high ion transmission efficiency even under a high pressure and can be fabricated at low cost.

In addition, according to one aspect of the present invention, it is made possible to provide a mass spectrometer or mass spectrometry method that reduces crosstalk in a wide mass range.

According to another aspect of the present invention, ion acceleration in the axial direction due to resonant excitation and the voltage at a frequency corresponding to a high mass are selectively increased, so that it is made possible to shorten a time period for which ions in a wide mass-to-charge ratio range stay in the collision cell for reducing crosstalk.

### BRIEF DESCRIPTION OF THE DRAWINGS

FIG. 1(A) is a diagram depicting an embodiment 1 according to this scheme.

FIG. 1(B) is an axial cross sectional view of the embodiment 1.

FIG. 1(C) is a radial cross sectional view of the embodiment 1.

FIG. 1(D) is a radial cross sectional view of the embodiment 1.

FIG. 2(A) is an illustration 1 depicting the effect of this scheme.

FIG. 2(B) is an illustration 2 depicting the effect of this scheme.

FIG. 2(C) is an illustration 3 depicting the effect of this scheme.

FIG. 3 is a voltage control diagram.

FIG. 4 is an illustration depicting the effect of this scheme.

FIG. 5 shows diagrams depicting an embodiment 2 according to this scheme.

FIG. 6 shows diagrams depicting an embodiment 3 according to this scheme.

FIG. 7 is a sequence diagram of the embodiment 3.

FIG. 8 is an illustration of the embodiment 3.

FIG. 9(A) is a diagram depicting an embodiment 4 according to this scheme.

FIG. 9(B) is a radial cross sectional view 1 of the embodiment 4.

FIG. 9(C) is a radial cross sectional view 2 of the embodiment 4.

FIG. 10 is an illustration of power supplies.

FIG. 11 is a diagram depicting an embodiment 5 according to this scheme.

FIG. 12 is an illustration of the embodiment 5.

FIG. 13 shows diagrams depicting an embodiment 6 according to this scheme.

FIG. 14 shows diagrams depicting another example of the quadrupole electrostatic electrode.

FIG. 15 is a schematic block diagram depicting a triple quadrupole mass spectrometer according to an embodiment of the present invention.

FIG. 16 is an illustration depicting examples of a power supply for forming an electric field and a z-axis electrostatic field formed thereby according to an embodiment of the present invention.

FIG. 17 is an illustration depicting an exemplary oscillation frequency of ions to a mass-to-charge ratio according to an embodiment of the present invention.

FIG. 18 is an illustration depicting an example of an auxiliary high frequency voltage frequency and a voltage according to an embodiment of the present invention.

FIG. 19 is a schematic block diagram depicting a quadrupole time-of-flight mass spectrometer according to an embodiment of the present invention.

### MODE FOR CARRYING OUT THE INVENTION

In the following, a first embodiment of the present invention will be described with reference to the drawings.

### Embodiment 1

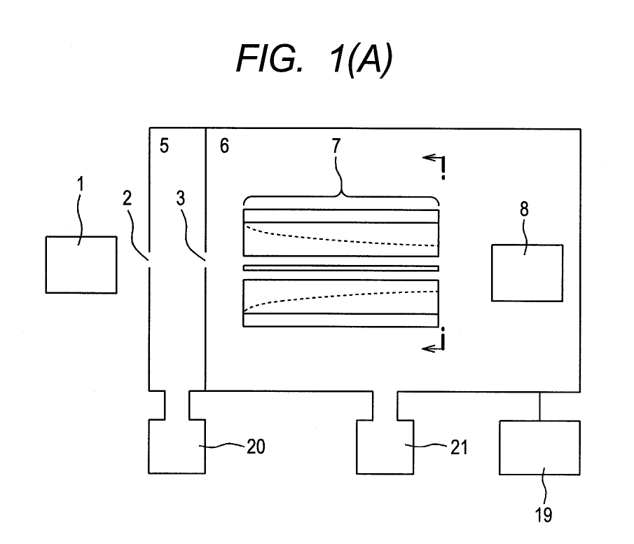

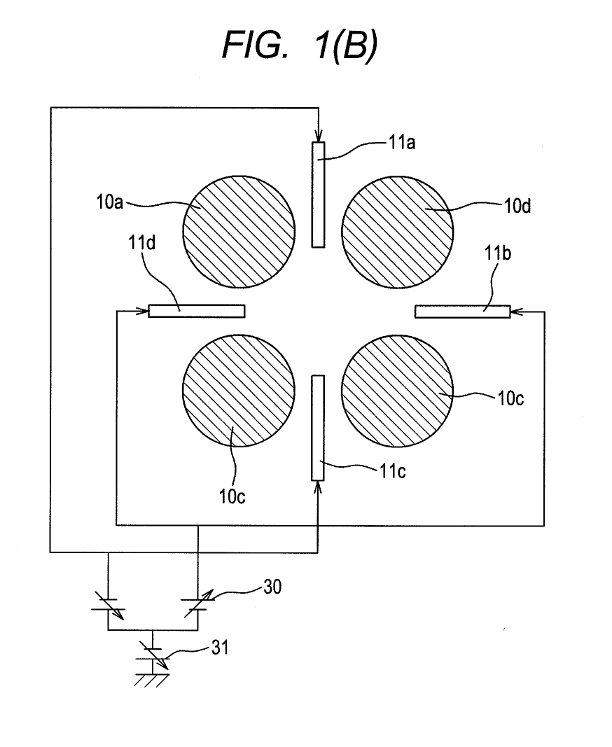

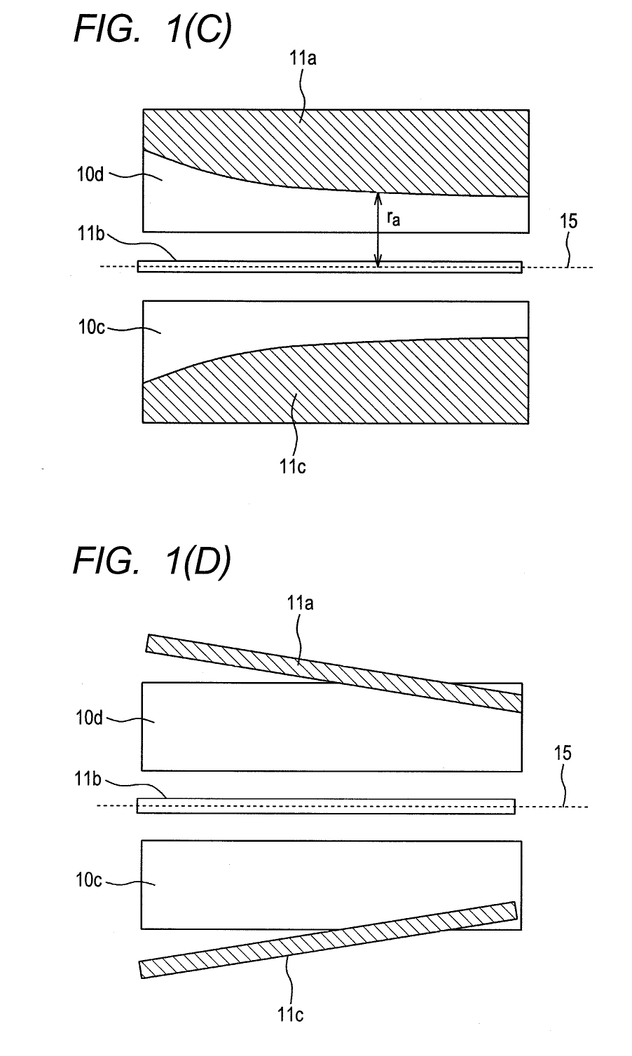

FIG. 1 shows block diagrams depicting a mass spectrometer according to this scheme. FIG. 1(A) is a diagram of the overall device, FIG. 1(B) is an axial cross sectional view depicting a quadrupole mass filtering unit 7, and FIGS. 1(C) and 1(D) are radial cross sectional views.

Ions produced in an ion source 1 such as an electrospray ion source, atmospheric pressure chemical ion source, atmospheric pressure optical ion source, atmospheric pressure matrix-assisted laser desorption/ionization source, and matrix matrix-assisted laser desorption/ionization source are passed through an aperture 2, and introduced into a differential pumping unit 5. The differential pumping unit is evacuated by a pump 20. The ions are passed from the differential pumping unit 5 through an aperture 3, and introduced into an analyzing unit 6. The analyzing unit is evacuated by a pump 21, and maintained at a pressure of 10⁻¹ Torr or below (1.3 Pa or below). The ions are introduced into a quadrupole mass filtering unit 7. The quadrupole mass filtering unit 7 is formed of quadrupole rod electrodes (10a, 10b, 10c, and 10d) and quadrupole electrostatic electrodes (11a, 11b, 11c, and 11d). Here, the quadrupole electrostatic electrode is an electrode that forms an electrostatic field on the axial center of quadrupole. FIG. 1 depicts this example. The plate shaped quadrupole electrostatic electrodes (11a, 11b, 11c, and 11d) are each inserted into the center part of the space between the adjacent quadrupole rod electrodes 10. The quadrupole electrostatic electrodes 11 are formed in such a shape that a distance rₐ between the quadrupole electrostatic electrodes 11 and the center axis 15 of the quadrupole is long on the inlet end side of the quadrupole rod electrodes 10, whereas rₐ is short on the outlet end side. It is also possible to insert a rod shaped electrode as shown in FIG. 1(D) instead of using a plate shaped quadrupole electrostatic electrode. Inserting a rod shaped electrode is inexpensive, which causes a greater influence of disturbing a quadrupole RF field more than a plate shaped electrode does.

The mass analyzing unit has a voltage control unit 19 that controls the voltage of the electrodes forming the quadrupole mass filtering unit 7. The ions ejected from the quadrupole mass filtering unit 7 are detected by a detector 8. For the detector, generally used are types of those combining an electron multiplier or a scintillator with a photo multiplier.

Although plus/minus a few tens V is sometimes applied to the offset potential of the quadrupole rod electrodes 10 depending on the previous and subsequent electrode voltages, in the following, it is defined as a value where the offset potential of the quadrupole rod electrodes 10 is zero, in describing the voltage of each individual electrode of the quadrupole rod electrodes 10. A high frequency voltage (quadrupole RF voltage) with an amplitude of about 100 to 5,000 V and a frequency of 500 kHz to 2 MHz is applied to the quadrupole rod electrodes 10. At this time, a quadrupole RF voltage in the same phase is applied to the opposing quadrupole rod electrodes (in the drawing (10a and 10c) and (10b and 10d), in the following, this definition is applied), whereas a quadrupole RF voltage in an anti-phase is applied to the adjacent quadrupole rod electrodes (in the drawing (10a and 10b), (10b and 10c), (10c and 10d), and (10d and 10a), in the following, this definition is applied).

For the quadrupole electrostatic electrodes 11, a positive electrostatic voltage is applied as a quadrupole electrostatic voltage to an opposing pair (11a and 11c, or 11b and 11d) of the quadrupole electrostatic electrodes 11, whereas a negative electrostatic voltage of the same amplitude is applied to the other pair (11b and 11d or 11a and 11c). The amplitude of the electrostatic voltage at this time is defined as the amplitude of the quadrupole electrostatic voltage. In addition, for the quadrupole electrostatic electrodes 11, all the quadrupole electrostatic electrodes are applied with an electrostatic voltage of the same polarity and the same amplitude as an offset voltage superimposed on the quadrupole electrostatic voltage.

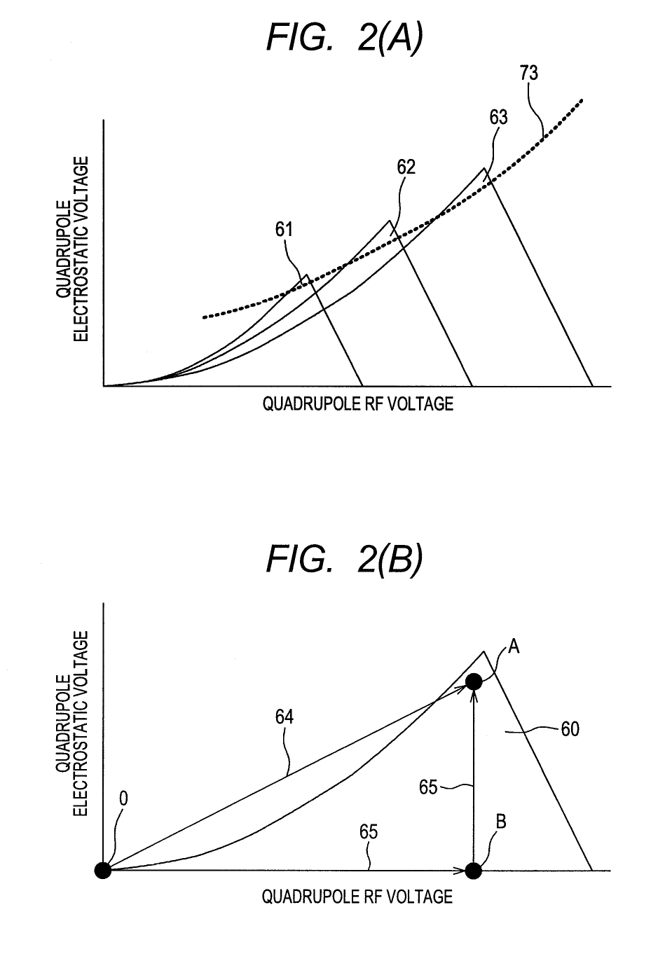

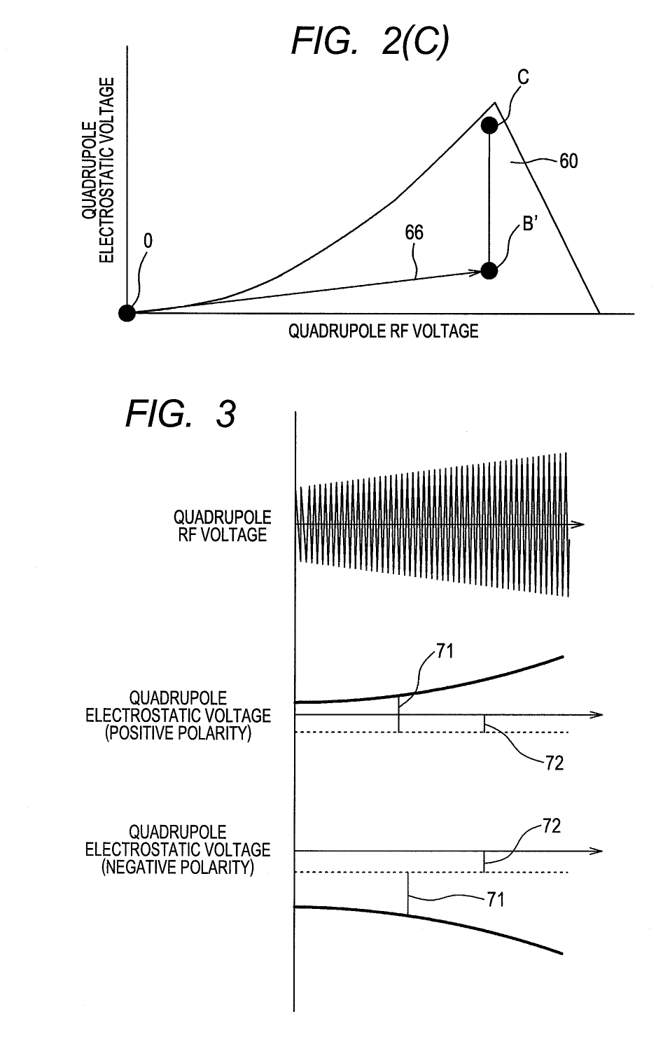

The operation of the quadrupole mass filter will be described. In the quadrupole mass filter, only ions existing inside a stable region 60 shown in FIGS. 2(B) and 2(C) are allowed to pass the quadrupole mass filter. The stable region is different for each m/z of the ion; the stable regions are arranged in a relationship from ions with a smaller m/z to ions with a larger one as shown in FIG. 2(A). If a quadrupole RF voltage and a quadrupole electrostatic voltage are selected and controlled near the top of a stable region for a certain m/z by the voltage control unit, only the ions with this m/z are allowed to pass. Moreover, if a quadrupole RF voltage is scanned while the relationship between the quadrupole RF voltage and the quadrupole electrostatic voltage is maintained so as to pass near the tops of the stable regions (61, 62, and 63) of ions with the individual m/z as a scan line 73 shown in FIG. 2(A), a mass spectrum can be obtained. The measuring sequence at this time is shown in FIG. 3. For the voltage application to the quadrupole electrostatic electrodes 11, the electrode to which a positive quadrupole electrostatic voltage is applied and the electrode to which a negative quadrupole electrostatic voltage is applied are separately shown in FIG. 3. In the case where positive ions are measured, an offset voltage 72 of about −1 to −100 V is applied to the quadrupole electrostatic electrodes 11, with respect to the offset potential of the quadrupole rod electrodes. A quadrupole electrostatic voltage 71 is further applied as superimposed on the offset voltage. The amplitude of the quadrupole electrostatic voltage 71 is controlled so as to satisfy the relationship of the scan line 73 in FIG. 2(A) depending on the amplitude of the quadrupole RF voltage. At this time, for the component of the quadrupole electrostatic voltage from which the offset voltage is subtracted, the amplitudes of the voltage of the positive polarity and the voltage of the negative polarity are always the same. Furthermore, in the case where negative ions are measured, it is sufficient to invert only the polarity of the offset voltage in the measuring sequence shown in FIG. 3.

The influence of a fringing field will be described with reference to FIG. 2(B). Ions just before entering the quadrupole mass filter are positioned at an origin point (coordinates) 0 because neither a quadrupole RF field nor a quadrupole electrostatic field is applied thereto. In the inside of the quadrupole mass filter, a quadrupole RF field and a quadrupole electrostatic field are applied, and the ions are positioned at a point A near the top of the stable region. Thus, the ions entering the quadrupole mass filter beyond the fringing field move outside the stable region, causing ion loss. A transition 64 of ions at this time is shown in FIG. 2(B). On the other hand, in the case where a Brubaker lens is used as Patent Document 2, because ions are passed through a point B at which only a quadrupole RF field is applied, the ions always move inside the stable region to avoid ion loss caused by a fringing field. A transition 65 of ions at this time is shown in FIG. 2(B).

Next, the effect of this scheme will be described with reference to FIG. 2(C). Because the quadrupole electrostatic electrodes 11 are apart from the center axis 15 on the inlet side of the quadrupole mass analyzing unit, a quadrupole electrostatic voltage applied to the center axis becomes small. Thus, the incoming ions move inside the stable region via the point B′ inside the stable region. Because of this, it is possible to reduce ion loss caused by a fringing field when ions enter the quadrupole mass filter, according to the similar effect as the Brubaker lens. A transition 66 of ions at this time is shown in FIG. 2(C).

The distance between the quadrupole electrostatic electrodes 11 and the center axis 15 comes closer as ions travel on the center axis in the direction of the outlet end. Because of this, the quadrupole electrostatic voltage that ions sense is increased. Ions travel upward inside the stable region shown in FIG. 2(C), and finally reach a point C that corresponds to the outlet end at which the quadrupole electrostatic voltage is the largest. The mass resolution of the quadrupole mass filtering unit 7 depends on the magnitude of the quadrupole electrostatic voltage that ions sense near the outlet end.

An offset voltage of the reverse polarity of the ions to pass is applied to the quadrupole electrostatic electrodes 11, so that it is possible to form an electric potential gradient on the center axis and to accelerate ions in the direction of the outlet end of the quadrupole mass filter. The slope of the electric potential gradient depends on the shape of the quadrupole electrostatic electrodes 11. With the used of the quadrupole electrostatic electrodes 11 in a shape in which the distance rₐ between the quadrupole electrostatic electrodes 11 and the center axis 15 is increased by the square of the distance from the exit of the quadrupole mass filter, the slope of the electric potential gradient on the center axis becomes constant regardless of the position on the center axis, allowing ions to be accelerated at constant acceleration. In the case where the shape of the four quadrupole electrostatic electrodes 11 is symmetry to the center axis 15, the potential produced by the quadrupole electrostatic voltage is always zero on the center axis. Thus, it is sufficient to consider only the potential for the amount of the offset voltage on the center axis. In addition, it is also possible to form an electric potential gradient on the center axis if an offset potential is applied only to the two quadrupole electrostatic electrodes (11a and 11c, or 11b and 11d).

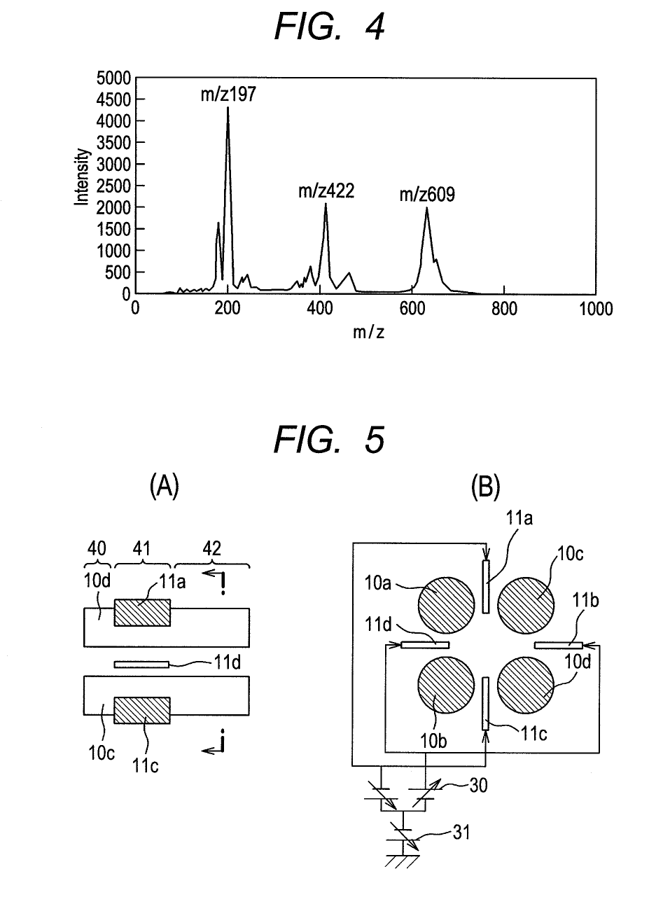

In order to confirm that a quadrupole electrostatic voltage is applied to the quadrupole electrostatic electrodes 11 to allow mass separation, only a quadrupole electrostatic voltage was applied to the quadrupole electrostatic electrodes 11 for measurements. The results are shown in FIG. 4. A reserpine/methanol solution at 100 ppm was used for a sample for electrospray ionization. In addition, a pressure inside the quadrupole mass filter was set to a pressure of 3.3 mTorr. The peaks of reserpine and its fragment ions were observed at an m/z 609, an m/z 197, and an m/z 422. The ion transmission efficiency of the m/z 609 at this time was 25%. From the results above, it was demonstrated that the quadrupole mass filter according to this scheme allows mass separation.

In the embodiment 1, it is unnecessary to use a plurality of pairs of quadrupole rods as the case of using the Brubaker lens. Because of this, it is possible to simplify the structure. Moreover, there is an advantage of simplifying the power supply because only a quadrupole RF voltage is applied to the quadrupole rod electrodes. Furthermore, it is possible to form an electric potential gradient on the center axis according to this scheme. Thus, ions do not come to a stop, and it is made possible to implement a high transmission efficiency even under a high pressure (0.5 mTorr or more).

### Embodiment 2

In an embodiment 2, a configuration will be described in which both ends of the quadrupole electrostatic electrodes 11 exist inner than both ends of the quadrupole rod electrodes 10.

FIG. 5(A) is an axial cross sectional view depicting the mass spectrometer, to which this scheme is implemented. Moreover, FIG. 5(B) is a radial cross sectional view seen from the direction of an arrow shown in FIG. 5(A). Furthermore, FIG. 5(B) shows a manner of voltage application to the quadrupole electrostatic electrodes 11. The device configuration to a quadrupole mass filtering unit 7 and the device configuration after the quadrupole mass filtering unit 7 are the same as those in the embodiment 1 for omission.

In the quadrupole mass filtering unit 7, quadrupole electrostatic electrodes are disposed in the inner side of quadrupole rods, as formed of an inlet side focusing section 40, a mass separating section 41, and an exit side focusing section 42. The quadrupole RF voltage amplitude of the quadrupole rods and the amplitude of the quadrupole electrostatic electrodes are controlled by the similar method as shown in the embodiment 1, so that it is possible to pass only the ions in a specific m/z range.

A quadrupole electrostatic voltage is not applied to the inlet side focusing section 40. Because of this, it is possible to reduce ion loss caused by a fringing field according to the similar effect as the Brubaker lens. In addition, it is also possible to avoid ion loss caused by a fringing field formed at the outlet end by the exit side focusing section 42. Although the ions ejected from the mass separating section 41 are in the state in which the distribution is spread in the radial direction, the kinetic energy is cooled by collision against a neutral gas while the ions are passing through the exit side focusing section 42, and the ion distribution in the radial direction is focused.

An offset voltage of the same polarity as that of ions is applied to the quadrupole electrostatic electrodes 11, so that it is made possible to prevent ions once having passed through the mass separating section 41 from again returning to the mass separating section 41. Because the cooling effect caused by the collision against a neutral gas is small near the inlet of the quadrupole mass filter, ions can pass through the mass separating section 41 at the initial kinetic energy. The ions having passed through the mass separating section 41 are introduced into the exit side focusing section 42. Because a quadrupole electrostatic field is not applied to the exit side focusing section 42, it is possible to suppress loss to a small loss even though ions come to a stop. The ions that stay in the exit side focusing section 42 are pushed out due to the repulsion of ions supplied from the region, to which a quadrupole electrostatic voltage is newly applied, and are ejected from the quadrupole mass filter.

Because an electric potential gradient does not exist on the center axis in (the embodiment 2) as compared with (the embodiment 1), the ion transmission efficiency is poor. On the other hand, processing the quadrupole electrostatic electrodes is simpler, and it is possible to fabricate them cheaper than in (the embodiment 1). In addition, because the ion kinetic energy is focused in the exit side focusing section, the ion introduction efficiency to the mass analyzing unit in the subsequent stage is increased more than in the embodiment 1 in performing tandem mass analysis.

### Embodiment 3

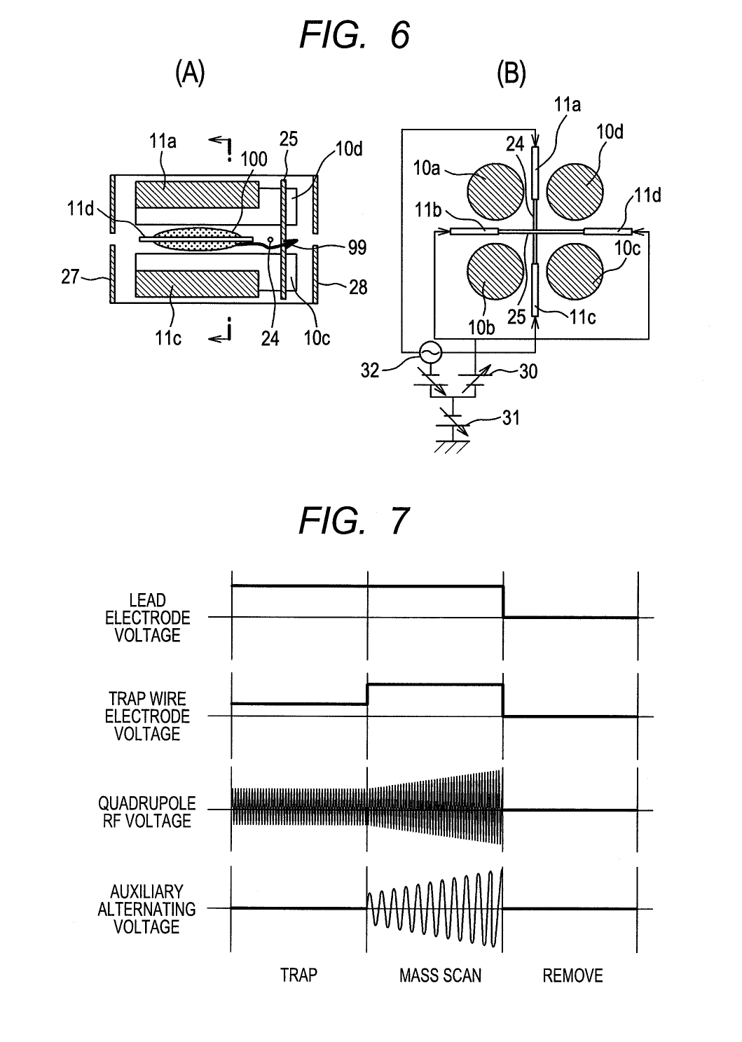

In an embodiment 3, the configuration will be described in which this scheme is incorporated in a linear ion trap. The structure of a linear ion trapping unit is shown in FIG. 6. The linear ion trapping unit is formed of an inlet end electrode 27, quadrupole rod electrodes 10, an outlet end electrode 28, quadrupole electrostatic electrodes 11, a trap wire electrode 24, and a lead wire electrode 25. A buffer gas is introduced into the linear ion trapping unit, which is maintained at a pressure of about 10⁻⁴ Torr to 10⁻² Torr (1.3×10⁻² Pa to 1.3 Pa).

FIG. 7 shows the measuring sequence of the linear ion trapping unit. The measurement is performed in three sequences, trapping, mass scanning, and removal. In a trap time period, a voltage of the same polarity as that of ions to be measured is applied to the inlet end electrode 27 and the trap wire electrode 24. Because of this, the ions introduced into the linear ion trapping unit are trapped in a region 100 sandwiched between the inlet end electrode 27, the quadrupole rod electrodes 10, and the trap wire electrode 24. The voltage application to the quadrupole electrostatic electrodes 11 and the effect in the trap time period will be described later. In a mass scanning time period, the quadrupole RF voltage amplitude is changed while an auxiliary alternating voltage (an amplitude of 0.1 to 100 V, and a frequency of 10 kHz to 500 kHz) is applied to an opposing pair of the quadrupole electrostatic electrodes 11 (a and b), so that ions are mass selectively ejected. In the case where positive ions are measured, the inlet end electrode 27 is set from about 10 V to 100 V, the outlet end electrode 28 from about 0 to −50 V, the trap wire electrode 24 from about 5 to 30 V, and the lead wire electrode 25 from about 0 to −50 V. The ions with m/z resonating with the auxiliary alternating voltage are vibrated and excited in the radial direction, and ejected in the axial direction beyond the potential barrier of the trap wire electrode 24 as a trajectory 99 shown in FIG. 6. On the other hand, the ions with m/z not resonating with the auxiliary alternating voltage stay in the region 100 sandwiched between the inlet end electrode 27, the quadrupole rod electrodes 10, and the trap wire electrode 24. In the mass scanning time period, if the strength of the quadrupole electrostatic field is set to zero, it is possible to relax the distortion of the quadrupole RF field for improving the mass resolution of the linear ion trap. Lastly, in a ejection time period, the voltage amplitude of the quadrupole RF voltage is set to zero, and all the ions are ejected out of the trap.

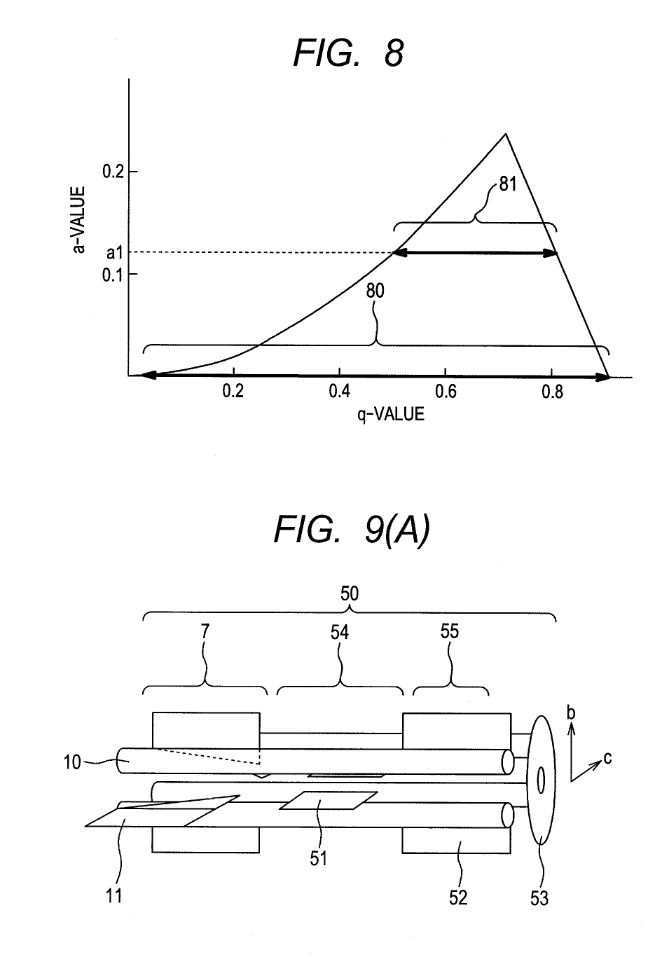

In the following, the effect of the voltage application to the quadrupole electrostatic electrode in the trap time period will be described. Ions with all of m/z can be expressed as shown in FIG. 8, where the stable region of the ions in the quadrupole mass filter shown in FIG. 2 is rewritten using an a-value and a q-value defined by the following Equations.

$$\begin{matrix}[ Equation 1 ] & \\ a = \frac{8 eU}{{mr}_{0}^{2} {Ω}^{2}} & ( Equation 1 ) \\ [ Equation 2 ] & \\ q = \frac{4 eV}{{mr}_{0}^{2} {Ω}^{2}} & ( Equation 2 )\end{matrix}$$

At this time, r₀ is the distance between the rod electrodes 10 and the center of the quadrupole, m is the m/z of the ion, W is the angular frequency of the quadrupole RF voltage, U is the strength of the quadrupole electrostatic voltage, and V is the amplitude of the quadrupole RF voltage.

In the case where a quadrupole electrostatic voltage is not applied to the quadrupole electrostatic electrodes 11, the ions with all of m/z satisfying the q-value (0 to 0.903) in a range 80 shown in FIG. 8 are trapped. On the other hand, on applying a quadrupole electrostatic voltage that the a-value is a1 to the quadrupole electrostatic electrodes 11, the q-value existing in the stable region is limited in a range 81 shown in the drawing. Because of this, only the ions with m/z corresponding to the q-value existing in the stable region are trapped, and the ions with the other m/z are ejected. The m/z range of the ions to be trapped is narrowed to suppress the space charge of the linear ion trap. The m/z range of the ions to be trapped can be adjusted by changing the strength of the quadrupole electrostatic voltage. As shown in the drawing, if the quadrupole electrostatic voltage is more increased, the m/z range of the ions to be trapped is made narrower. The effect of suppressing space charge is more increased, as the mass range of ions to be trapped is narrower. On the other hand, because the mass range that can be analyzed for a single trap operation is narrowed, duty cycle is reduced. Here, the duty cycle shows the ratio of the ions that are mass selectively ejected from the ions introduced into the analyzing unit.

### Embodiment 4

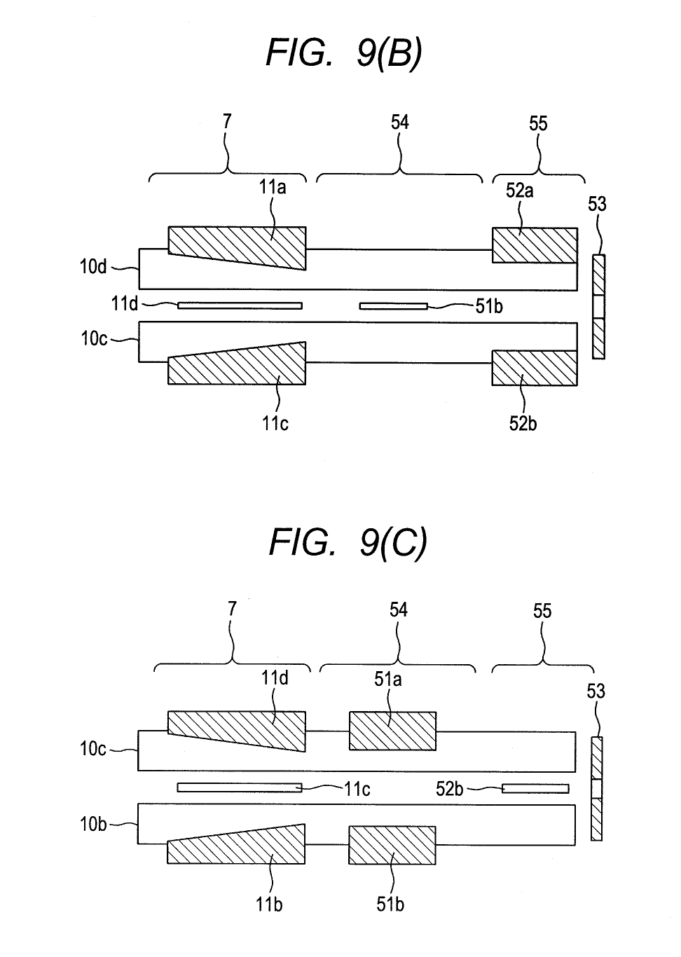

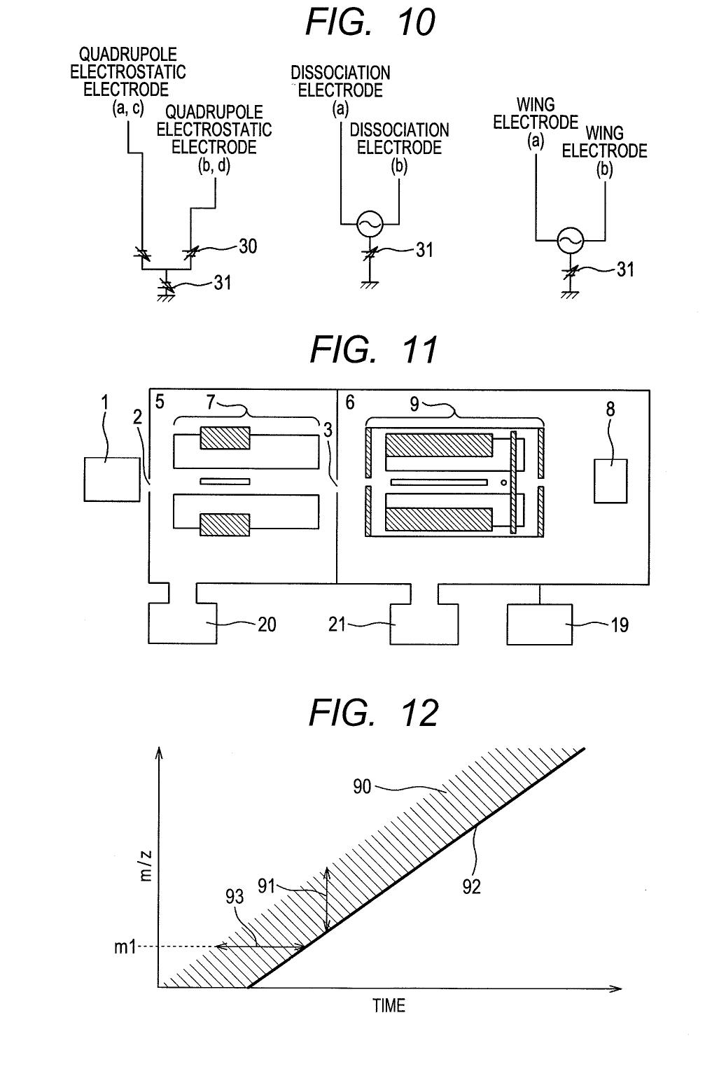

In an embodiment 4, described is a method of implementing a triple quadrupole mass spectrometer that is operable even under a high pressure and producible at low cost using this scheme. FIG. 9(A) is a block diagram depicting a mass spectrometer to which this scheme is implemented. Moreover, FIGS. 9(B) and 9(C) are cross sectional views. Furthermore, FIG. 10 shows manners of voltage application to quadrupole electrostatic electrodes 11, dissociation electrodes 51, and vane electrodes 52.

The device configuration to a triple quadrupole unit 50 and the device configuration after a mass analyzing unit are the configuration in which the quadrupole mass filtering unit of the embodiment 1 is replaced by the triple quadrupole unit 50. The triple quadrupole unit 50 is formed of quadrupole rod electrodes 10, four quadrupole electrostatic electrodes 11, two collision induced dissociation electrodes 51, and two vane electrodes 52. The offset voltage to be applied to the quadrupole electrostatic electrodes 11, the collision induced dissociation electrodes 51, and the vane electrodes 52 is set in such a way that the electrostatic potential is lower in order of the quadrupole electrostatic electrodes, the collision induced dissociation electrodes, and the vane electrodes. The operation of a quadrupole mass filtering unit 7 is the same as that in (the embodiment 1) for omission.

Ions having passed through the quadrupole mass filtering unit 7 are introduced into a dissociating unit 54. In the dissociating unit 54, the collision induced dissociation electrode 51 is applied with an auxiliary alternating voltage (an amplitude of 0.01 to 100 V, and a frequency of 10 kHz to 500 kHz) at a frequency with which ions targeted for dissociation resonate, so that the ions with m/z, which are targeted for dissociation, are vibrated and excited in the direction of the collision induced dissociation electrode 51. The ions vibrated and excited are dissociated into fragment ions by collision against neutral molecules. The fragment ions produced in the dissociating unit 54 are introduced into a mass analyzing unit 55.

In the case where positive ions are measured, a voltage of about 0.1 to 100 V is applied to the outlet end electrode 53 for forming a potential barrier. On applying an auxiliary alternating voltage (an amplitude of 0.01 to 100 V, and a frequency of 10 kHz to 500 kHz) to the vane electrodes 52, ions with m/z resonating with the frequency of the auxiliary alternating voltage are excited in the direction of the vane electrodes 52. Because the excited ions are increased in energy in the axial direction due to a fringing field, the ions are ejected from the outlet end electrode 53 beyond the potential barrier. Because the ions not resonance excited cannot pass the potential barrier of the outlet end electrode 53, the ions stay inside the mass analyzing unit 55.

It is also possible to obtain the mass spectrum of the fragment ions if the frequency of the auxiliary alternating voltage to be applied to the vane electrodes 52 is swept. The pressure of the mass analyzing unit 55 is more lowered than that of the dissociating unit 54 as by providing a barrier between the dissociating unit 54 and the mass analyzing unit 55, so that it is possible to prevent the fragment ions from additionally decomposing in the mass analyzing unit. In addition, the mass resolution and sensitivity are improved in the mass analyzing unit 55. The exciting direction by the collision induced dissociation electrode 51 and the exciting direction by the vane electrodes 52 are set orthogonal to each other, so that it is possible to increase the signal-to-noise ratio.

Unlike typical triple quadrupole mass spectrometers, there is an advantage that the configuration is simple and inexpensive because it is unnecessary to split the rod. In addition, the quadrupole mass filter of this embodiment is operable at a higher pressure (about 1 mTorr (1.3 to 1 Pa)) as compared with typical quadrupole mass filters. For this reason, it is also possible to use a pump or the like of a small capacity.

### Embodiment 5

The configuration will be described in which the quadrupole mass filter according to this scheme is connected to an ion trap in series for mass analysis with reference to FIG. 11. Ions produced in an ion source 1 are passed through an aperture 2, and introduced into a differential pumping unit 5. The differential pumping unit 5 is evacuated by a pump 20, and maintained at a pressure of about 10⁻¹ Torr or below (13 Pa or below). The ions introduced into the differential pumping unit 5 are subjected to mass separation in a quadrupole mass filtering unit 7, the ions in a specific mass range, which are passed through the quadrupole mass filtering unit 7, are passed through an aperture 3, and introduced into an analyzing unit 6. The analyzing unit 6 is evacuated by a pump 21, and maintained at a pressure of 10⁻⁴ Torr or below (1.3 to 2 Pa or below). The ions introduced into the analyzing unit 6 are subjected to mass separation in an ion trapping unit 9, and then detected at a detector 8.

The structure and voltage control of the quadrupole mass filtering unit 7 are the same as those in the embodiment 2, for omission.

It is sufficient that the ion trapping unit 9 can trap ions in a certain mass range and mass selectively eject ions. It is possible that for the operation, the ion trapping unit repeats the operations of trapping, mass scanning, and removal as shown in the embodiment 3, or performs mass scanning while introducing ions into the ion trap.

In addition, the quadrupole mass filtering unit 7 controls the mass range of the ions ejected from the quadrupole mass filtering unit 7 as matched with the mass range of the ions ejected from the ion trapping unit 9 as in the case of the embodiment 3, so that it is possible to suppress the space charge of the ion trap. Because the amount of the ions to be introduced into the ion trapping unit 9 is reduced if the mass range of the ions to pass through the quadrupole mass filtering unit 7 is narrowed, the effect of suppressing the space charge of the linear ion trapping unit is more increased. On the other hand, the duty cycle is decreased.

In the case where mass scanning is performed while ions are being introduced into the ion trapping unit 9, it is also possible to control the mass range of the ions to pass through the quadrupole mass filtering unit 7 and the mass range of the ions to be ejected from the ion trapping unit as they are in association with each other.

A mass range 90 of ions to pass through the quadrupole mass filtering unit is shown in FIG. 12; time is plotted on the horizontal axis, and m/z is plotted on the vertical axis. An m/z 91 of the ions to be ejected from the ion trapping unit is also shown in the same drawing. The m/z range of the ions to pass through the quadrupole mass filtering unit and the m/z of the ions to be ejected from the ion trapping unit are scanned at the same velocity. At this time, the m/z range of the ions to be ejected from the quadrupole mass filtering unit is set greater than the m/z of the ions to be ejected from the ion trapping unit. At this time, a time period 93 for which ions with a certain m/z are trapped in the ion trapping unit is determined according to the m/z range and scanning velocity of the ions to pass through the quadrupole mass filtering unit. The m/z range of the ions to be ejected from the quadrupole mass filtering unit is adjusted according to the amount and scanning velocity of ions to be introduced, so that it is made possible to implement a high duty cycle while suppressing space charge.

Next, the advantage will be described in which the quadrupole mass filtering unit and the ion trapping unit are placed in vacuum chambers at different pressures. The differential pumping unit has a high ion cooling efficiency because of a high pressure in the unit, and the unit can efficiently focus the ion energy distribution spread due to the quadrupole electrostatic field in the quadrupole mass filter. For this reason, it is possible to efficiently introduce the ions with the focused energy distribution into the mass analyzing unit in the subsequent stage. On the other hand, it is possible to set the pressure inside the ion trapping unit low by placing the ion trapping unit in the analyzing unit, in which the pressure is low, and it is made possible to improve the mass resolution and the ejection efficiency as compared with the condition that the pressure inside the ion trapping unit is high.

### Embodiment 6

The configuration will be described in which a quadrupole mass filter according to this scheme is connected in series to an RF only quadrupole mass filter in the subsequent side for mass analysis. The device configurations other than the quadrupole mass filtering unit and the RF only quadrupole mass filtering unit are the same as those in the embodiment 5 for omission.

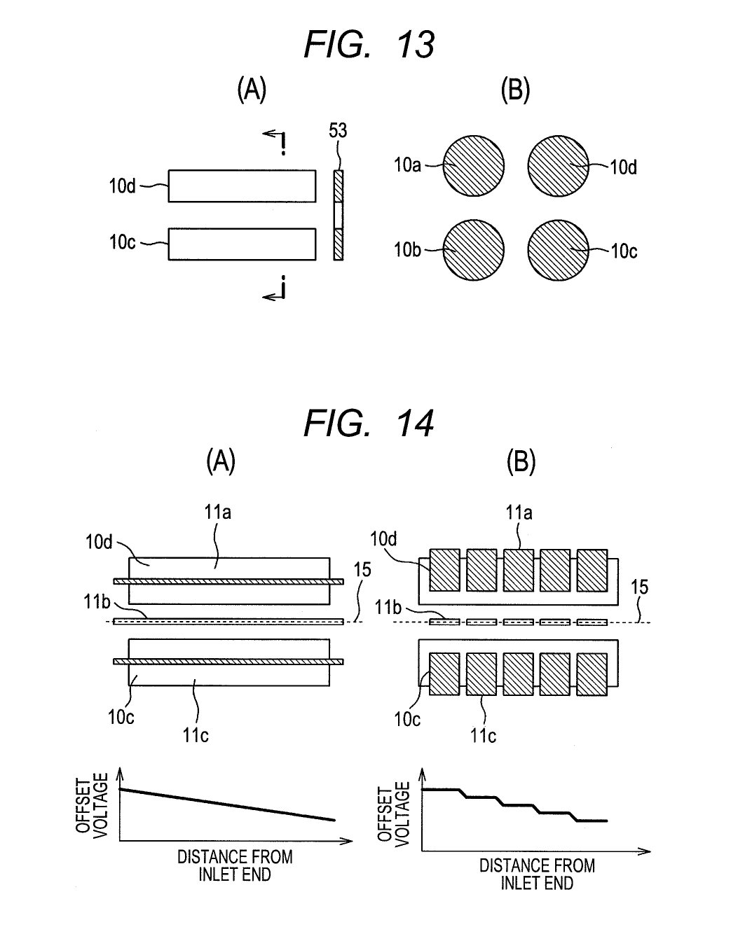

The structure and voltage control of the quadrupole mass filtering unit 7 are the same as those in the embodiment 1 or the like. FIG. 13(A) is an axial cross sectional view depicting the RF only quadrupole mass filtering unit. In addition, FIG. 13(B) is a radial cross sectional view seen from the direction of an arrow shown in FIG. 13(A). The RF only quadrupole mass filter is formed of quadrupole rod electrodes and an outlet end electrode. In the case where positive ions are measured, a voltage of about 0.1 to 100 V is applied to the outlet end electrode 53 for forming a potential barrier. The ions positioned at the boundary of the stable region are increased in the distribution in the radial direction, and the energy in the axial direction is increased due to a fringing field. Thus, the ions are ejected from the outlet end electrode 53 beyond the potential barrier. On sweeping the quadrupole RF voltage, the mass spectrum can be obtained.

In the case where only ions with a specific m/z are continuously passed, only ions with m/z positioned at the boundary of the stable region are ejected. Thus, the ions with the other m/z stay inside the quadrupole mass filtering unit. The mass of the ions to be ejected from the first quadrupole mass filtering unit is set near the boundary condition, so that it is possible to reduce the amount of ions staying inside the quadrupole mass filtering unit for suppressing the influence of space charge. As similar to the case where mass scanning is performed while introducing ions into the ion trapping unit 9 in the embodiment 5, the quadrupole mass filtering unit 7 in the previous stage and the quadrupole mass filtering unit in the subsequent stage are controlled as they are in association with each other, so that it is also made possible to implement a high duty cycle while suppressing space charge.

Moreover, the RF only quadrupole mass filter is more reduced in the resolution as the energy distribution of incoming ions is more spread. However, in this embodiment, the quadrupole mass filtering unit, in which the pressure is high, allows the ion energy distribution in the axial direction to be focused.

In addition, although it is common to the embodiment 1, it is sufficient that the shape and material of the quadrupole electrostatic electrodes 11 allow such settings that the strength of the quadrupole electrostatic electrodes on the inlet side of the quadrupole electrostatic electrodes 11 and the potential due to the offset voltage are set lower than those on the exit side of the quadrupole electrostatic electrodes. For example, it is also possible that the quadrupole electrostatic electrodes 11 are formed of a resistive element and a quadrupole electrostatic voltage and an offset voltage with different strengths are applied to the inlet side end and exit side end of the quadrupole electrostatic electrodes 11, or that the quadrupole electrostatic electrodes 11 are split into more than one section in the axial direction and a quadrupole electrostatic voltage and an offset voltage with different strengths are applied to the individual electrodes. FIG. 14(A) shows an axial cross sectional view depicting the example that the quadrupole electrostatic electrodes 11 are formed of a resistive element, and FIG. 14(B) shows a cross sectional view depicting the example that the quadrupole electrostatic electrodes 11 are split.

In the following, a second embodiment of the present invention will be described with reference to the drawings.

### Embodiment 7

First, the configuration of this embodiment will be described.

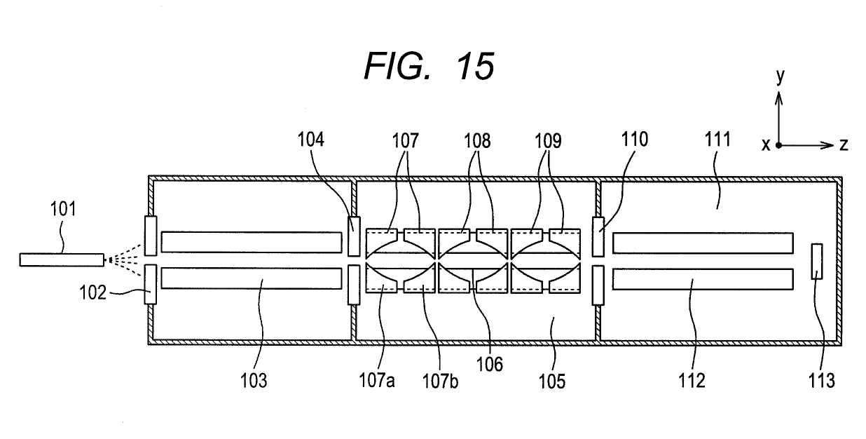

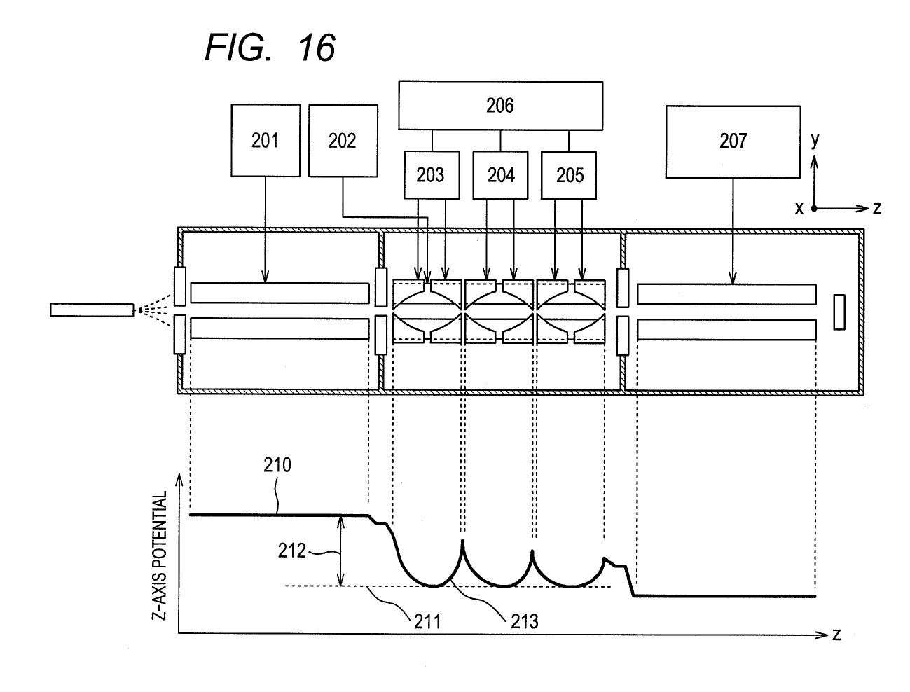

FIG. 15 shows a schematic block diagram depicting a device according to this embodiment in the case where the present invention is adopted to a triple quadrupole mass spectrometer. Moreover, FIG. 16 shows a power supply for forming an electric field and a z-axis electrostatic field formed thereby.

An ion source 101 ionizes a sample by applying a voltage of a few kV using a direct current power supply. Positively or negatively charged ions are passed through an aperture 102 having a diameter of about 0.2 to 0.8 mm, and introduced into a vacuum. A first stage quadrupole 103 in the subsequent stage is a quadrupole that produces a linear quadrupole electric field, superimposes an RF voltage on a direct current voltage and applies the voltage with supply from a first stage quadrupole direct/alternating power supply 201. The ratio between the RF voltage and the direct current voltage is constant to operate the voltage, so that it is made possible to pass only the ions with a specific mass-to-charge ratio. This specific mass-to-charge ratio is considered to be the mass-to-charge ratio of target ions for structure analysis. The target ions are ions subjected to collision induced dissociation, and considered to be object ions. The object ions are passed through an inlet aperture 104 in the subsequent stage, and introduced into a collision cell 105. The pressure inside the collision cell 105 is maintained at a pressure of about a few m Torr by introducing neutral molecules such as argon or nitrogen. A second stage quadrupole 106, a first stage vane electrode pair 107, a second stage vane electrode pair 108, and a third stage vane electrode pair 109 are arranged thereinside, which are constituents of the present invention. However, the stage number of the vane electrodes is not limited to three stages, which is the stage number that the electrodes reach one end to the other end of the second stage quadrupole 106 in the axial direction. The first stage vane electrode pair 107 is formed of a front vane electrode 107a and a rear vane electrode 107b, which are mirror symmetry. In FIG. 15, only the first stage is designated numeral references. However, the second stage vane electrode pair 108 and the third stage vane electrode pair 109 are similarly formed of a front vane electrode and a rear vane electrode. A high frequency voltage and a direct current voltage are applied to the second stage quadrupole 106 with supply from a second stage quadrupole direct/alternating power supply 202. The high frequency voltage forms a well potential in the XY-plane for trapping ions in the xy-direction. Moreover, the direct current voltage applies a voltage to trap and dissociate ions. The first stage vane electrode pair 107, the second stage vane electrode pair 108, and the third stage vane electrode pair 109 are electrodes that individually form a harmonic potential thereinside. A first stage vane electrode pair direct current power supply 203, a second stage vane electrode pair direct current power supply 204, and a third stage vane electrode pair direct current power supply 205 apply a direct current voltage to form a harmonic potential in the z-axis direction for trapping ions in the z-axis direction. In order to vary the direct current voltage to each of the vane electrode pairs in three stages, the vane electrode pairs individually include the direct current power supply (the first stage vane electrode pair direct current power supply 203, the second stage vane electrode pair direct current power supply 204, and the third stage vane electrode pair direct current power supply 205), and in order to superimpose the alternating voltages at a plurality of frequencies, a vane electrode pair alternating power supply 206 is provided, which is capable of combining frequencies. Thus, ions are resonance excited, and energy is provided. An aperture 110 in the z-axis direction is a vacuum barrier that partitions the collision cell 105 and a mass separating unit (quadrupole mass spectrometer) 111, which acts as an electrode by applying a direct current voltage. The ions ejected from the collision cell 105 are passed through the aperture 110, and introduced into the mass separating unit (quadrupole mass spectrometer) 111. The mass separating unit (quadrupole mass spectrometer) 111 includes a third stage quadrupole 112 and a detector 113. The alternating voltage is superimposed on a direct current voltage and applied, with supply from a third stage quadrupole direct/alternating power supply 207, so that ions are subjected to mass separation at the third stage quadrupole 112, and detected at the detector 113. With these configurations, an electrostatic field shown in FIG. 16 is formed on the z-axis.

Next, the above-mentioned method of accelerating ions in the embodiment of the present invention will be described. The object ions introduced into the collision cell obtain kinetic energy due to a potential difference 212 for collision induced dissociation, which is the potential difference between a first stage quadrupole direct current voltage potential 210 of the first stage quadrupole 103 and a second stage quadrupole direct current voltage potential 211 of the second stage quadrupole 106 in the collision cell 105, and the object ions collide against neutral molecules to cause ion cleavage. Because the ion cleavage regions are at random, fragment ions in a wide mass-to-charge ratio range are produced. The fragment ions are trapped inside the first stage vane electrode pair 107 due to a harmonic potential 213 that is formed by the first stage vane electrode pair, which is the harmonic potential formed by the front vane electrode 107a and the rear vane electrode 107b forming the first stage vane electrode pair 107, and the fragment ions are moved in simple harmonic motion at a frequency unique to the mass-to-charge ratio in the z-axis direction. Next, a vane electrode pair alternating voltage 206 with the same frequency as the oscillation frequency of ions corresponding to the measured mass-to-charge ratio range is applied to the front vane electrode 107a and the rear vane electrode 107b. This alternating voltage refers to an auxiliary high frequency voltage. The auxiliary high frequency voltage is turned in the anti-phase by the front vane electrode 107a and the rear vane electrode 107b. However, the electrode that applies the auxiliary high frequency voltage may be only one of the front vane electrode 107a and the rear vane electrode 107b. Moreover, the direct current voltage to be applied to the vane electrode pair is applied in such a way that a field slope is provided in order of the first stage vane electrode pair 107, the second stage vane electrode pair 108, and the third stage vane electrode pair 109. In the case where ions are positive ions, the direct current voltage therefor is set in such a way that the first stage is higher than the third stage. Furthermore, in the case where ions are negative ions, the direct current voltage is set low. The auxiliary high frequency voltage and the direct current voltage cause the fragment ions to be resonance excited in the x-axis direction for obtaining energy, and the fragment ions obtain a potential exceeding the harmonic potential, so that the fragment ions are emitted on the second stage vane electrode pair 108 side. Then, the fragment ions are trapped in the second stage vane electrode pair 108, the voltage is operated as similar to the first stage vane electrode pair 107, and the fragment ions are resonated and emitted in the direction of the third stage vane electrode pair 109. This is in turn repeated to allow the fragment ions to obtain energy in the direction of the third stage quadrupole 112. Then, the fragment ions are passed through the aperture 110, which is the barrier electrode between the collision cell 105 and the third stage quadrupole 112, for performing mass separation at the third stage quadrupole 112. This allows the measurement of the signal of the fragment ions.

Next, ion trapping, resonant excitation, which are operations in the harmonic potential, will be described. A direct current voltage is applied to the front vane electrode 107a and the rear vane electrode 107b to produce a z-axis direction potential D (z) on the z-axis, which is the center of the quadrupole. The z-axis direction potential D (z) is expressed by Equation 3 from a distance z from the center between the front vane electrode 107a and the rear vane electrode 107b.

$$\begin{matrix}[ Equation 3 ] & \\ D ( z ) \approx {D}_{0} ( \frac{z}{L} ) & ( Equation 3 )\end{matrix}$$

In the equation, D₀ is the depth of the harmonic potential, and L is the distance from the center between the front vane electrode 107a and the rear vane electrode 107b to the end point of the vane electrode. On introducing ions into the harmonic potential due to the z-axis direction potential, the ions obtain the force to travel toward the center between the front vane electrode 107a and the rear vane electrode 107b. Thus, the ions are moved in simple harmonic oscillation in the z-axis direction, and trapped. The frequency f is expressed by Equation 4, which is inversely proportional to the square root of the mass-to-charge ratio. In the equation, e is the elementary charge, n is the ion charge number, and m is the ion mass.

$$\begin{matrix}[ Equation 4 ] & \\ f = \frac{1}{2 π} \sqrt{\frac{2 enD}{{mL}^{2}}} & ( Equation 4 )\end{matrix}$$

On applying an auxiliary high frequency voltage at a frequency corresponding to the mass-to-charge ratio of the ions to be resonance excited to the vane electrode, the ions are resonance excited in the z-axis direction, and allowed to obtain kinetic energy in the z-axis direction. At this time, the alternating voltage is applied to the two vane electrodes in the anti-phase, or applied to one of the two vane electrodes. Moreover, in the present invention, in order to resonance excite all the ions trapped in the harmonic potential, the frequency of the auxiliary high frequency voltage is calculated from the mass-to-charge ratio, which is min in Equation 4, and superimposed and applied. At this time, in order to efficiently eject ions with a high mass-to-charge ratio, the amplitude of the frequency, with which the high mass-to-charge ratio resonate, is set higher than a low mass-to-charge ratio.

For example, the case is shown where L is 25 mm, the direct current voltage of the quadrupole is 2 V, and the direct current voltage of the vane electrode pair in the first, second, and third stages are 11 V, 9 V, and 7 V. Because the depth of the harmonic potential D₀ of each of the vane electrode pairs can be estimated from the difference between the direct current voltage of the vane electrode pair and the direct current voltage of the quadrupole, the depth of the harmonic potential of the individual vane electrode pairs is about 9 V, 7 V, and 5 V.

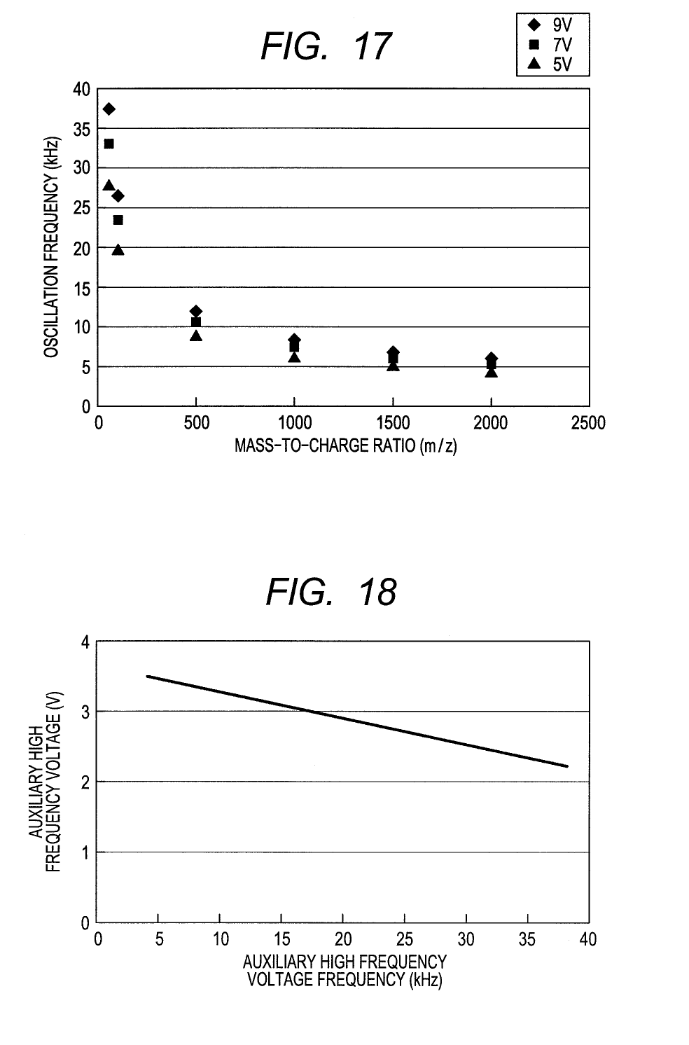

FIG. 17 shows the relationship of the ion oscillation frequency to the mass-to-charge ratio calculated from Equation 4. The oscillation frequency has the relationship of inverse proportion to the mass-to-charge ratio; the oscillation frequency is higher as the mass-to-charge ratio is lower, whereas the oscillation frequency is lower as the mass-to-charge ratio is higher. In addition, the oscillation frequency is proportional to the depth of the harmonic potential. For example, the oscillation frequency is about 13 kHz as the depth of the harmonic potential is 9 V, where the mass-to-charge ratio is an m/z of 500. On applying an auxiliary high frequency voltage at this frequency to the vane electrode pair, ions are resonance excited to obtain kinetic energy in the z-axis direction. In this embodiment, in order to resonance excite the ions with the mass-to-charge ratio in an m/z range of 50 to 2,000, an auxiliary high frequency voltage at a frequency of combined frequencies of 4 to 38 kHz is applied. Thus, the ions in an m/z range of 50 to 2,000 are resonance excited to obtain energy in the z-axis direction.

In addition, because this auxiliary high frequency voltage can be freely changed for each frequency, it is possible to freely change energy given to the mass-to-charge ratio. In other words, if the voltage of the auxiliary high frequency voltage is adjusted to control energy to be given for each of ions in crosstalk to each other in such a way that crosstalk is made small, it is possible to reduce crosstalk in a wide mass range. It is sufficient that the adjustment of the voltage of the auxiliary high frequency voltage is matched in such a way that the ion intensity of the mass spectrum in crosstalk is made smaller. For example, in the case where crosstalk is large in the ions with a high mass-to-charge ratio, a slope is provided for the auxiliary high frequency voltage with respect to the frequency as shown in FIG. 18. This gives the ions with a high mass-to-charge ratio with a low oscillation frequency a large energy with respect to the ions with a low mass-to-charge ratio. As a result, it is possible to reduce the crosstalk of ions in a wide range, independent of the mass-to-charge ratio.

### Embodiment 8

An embodiment will be described in which the present invention is implemented in a quadrupole time-of-flight mass spectrometer.

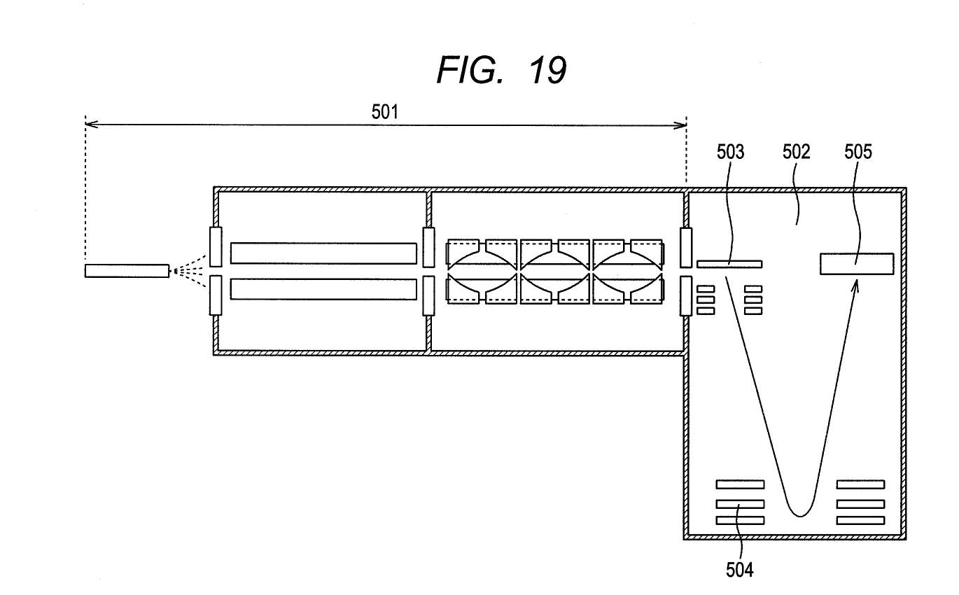

FIG. 19 shows a schematic block diagram depicting a quadrupole time-of-flight mass spectrometer according to this embodiment. A range 501 from an ion source to an aperture shown in FIG. 19 is the same configuration as that in the embodiment 1 shown above, and a mass separating unit (time-of-flight mass spectrometer) 502 provided in the subsequent stage is a time-of-flight mass spectrometer. The mass separating unit (time-of-flight mass spectrometer) 502 includes an accelerating electrode 503 that accelerates ions, reflecting electrodes 504 that uniformize kinetic energy, and a detector 505 that detects ions and converts the ions into a current value. In this embodiment, a orthogonal accelerating reflecting time-of-flight mass spectrometer is taken as an example. However, it is also possible to implement the embodiment in a method of performing acceleration in the z-axis direction, or in a method in which a detector is arranged in the traveling direction of ions with no use of the reflecting electrodes. Fragment ions are produced based on the configuration in the range 501 from the ion source to the aperture shown in FIG. 19 and the voltages, and the fragment ions are transported to the time-of-flight mass spectrometer 502. In the time-of-flight mass spectrometer 502, the high voltage of a transient signal is applied to the accelerating electrode 503. Thus, the ions obtain kinetic energy, the kinetic energy is uniformed at the reflecting electrodes 504, and then a time period for which the ions reach the detector 505 is measured. This time period is converted into a mass-to-charge ratio, and the current value from the detector is converted into the intensity. Thus, it is possible to obtain the mass spectrum of the fragment ions.

Moreover, the configuration of the mass separating unit (time-of-flight mass spectrometer) 502 is altered to other mass separators such as an ion cyclotron mass spectrometer (FT-ICR) in addition to this, so that it is possible to implement the present invention in mass spectrometers adapted to measurement objects and measurement samples.

As discussed above, tandem mass spectrometers such as a triple quadrupole mass spectrometer (Triple Q) and a quadrupole time-of-flight mass spectrometer (Q-TOF) are mass spectrometers that allow MS/MS, with features excellent in structure analysis and quantitative analysis. A collision cell is arranged in the middle of the tandem mass spectrometer for performing collision induced dissociation (CID: Collision Induced Dissociation). CID means that ions are caused to collide against neutral molecules to break the bonding between molecules. Thus, it is made possible to acquire the structural information or to perform quantitative determination of high sensitivity. However, because a reduction in the ion velocity and an expansion in the velocity distribution occur due to a reduction in ion kinetic energy in collision, a previous result remains in a subsequent result if a plurality of kinds of samples (ions) are measured. This generally refers to crosstalk, which causes unnecessary structural information to be displayed or a reduction in the accuracy of quantitative determination to occur. Moreover, a problem caused by the crosstalk becomes greater as the mass-to-charge ratio of ions is more increased. Against the foregoing problems, the vane electrodes are arranged in the collision cell for producing harmonic potentials in a plurality of stages. The fragment ions produced by collision induced dissociation are trapped inside the harmonic potential in the first stage. Because the trapped ions are moved in simple harmonic oscillation in the axial direction at a frequency dependent on the mass, the ions are resonance excited in the axial direction to obtain the kinetic energy traveling in the direction of the detector if the alternating voltage corresponding to this frequency is applied to the vane electrodes. This energy allows the time period for which ions stay in the collision cell to be short and crosstalk to be reduced. Moreover, it is possible to increase the ion velocity across the entire mass region even for ions with a high mass with a relatively small rate of travel by selectively increasing the voltage at a frequency corresponding to a high mass. In other words, ion acceleration in the axial direction due to resonance excitation and the voltage at a frequency corresponding to a high mass are selectively increased, so that it is possible to shorten the time period for which ions in a wide mass-to-charge ratio range stay in the collision cell for reducing crosstalk.

In addition, for example, the following features are described in this description.

1. In a mass spectrometer including: an ion source unit configured to ionize a sample; a first mass separating unit configured to select target ions from the ions generated in the ion source; a collision cell configured to perform collision induced dissociation for the selected ions; a second mass separating unit configured to select fragment ions produced by collision induced dissociation to again mass separation; and a detector configured to detect ions, in which a harmonic potential is formed in the inside of the collision cell, the fragment ions produced by collision induced dissociation are resonance excited in the inside of the collision cell, and energy is given to the ions in an axial direction.

2. In the above description 1, the collision cell traps ions in which a high frequency voltage is applied to a multipole such as a quadrupole or octopole for forming a quasi well potential in a perpendicular direction with respect to the traveling direction of the ions.

3. In the above description 1, a harmonic potential to be formed in the inside of the collision cell is formed in the axial direction in which a flat plate shaped electrode is arranged and a direct current voltage is applied thereto.

4. In the above description 1, an alternating voltage is superimposed on a harmonic potential to resonance excite the ions.

5. In the above description 4, the alternating voltage for resonant excitation is superimposed on voltages at a plurality of frequencies with which ions resonate to excite ions with all of mass-to-charge ratios.

6. In the above description 5, the alternating voltage for resonant excitation is allowed to change in the amplitude thereof in units of frequencies, and energy to be given to ions with individual mass-to-charge ratios is allowed to be individually set.

7. In the above description 6, an amplitude is controlled for individual frequencies so that ions with a first mass-to-charge ratio have a velocity the same as that of ions with a mass-to-charge ratio lower than the first mass-to-charge ratio.

8. In a mass spectrometry method including: ionizing a sample; selecting target ions from generated ions; performing collision induced dissociation for the selected ions; subjecting fragment ions produced by collision induced dissociation to again mass separation; and detecting ions, in which the produced fragment ions are resonance excited by a harmonic potential, and energy is give to the ions in an axial direction.

9. In the above description 8, if collision induced dissociation is performed for the selected ions, ions are trapped in which a high frequency voltage is applied to a multipole to form a quasi well potential in a perpendicular direction with respect to a traveling direction of the ions.

10. In the above description 8, the harmonic potential is formed in the axial direction by applying a direct current voltage to a flat plate shaped electrode.

11. In the above description 8, an alternating voltage is superimposed on the harmonic potential to resonance excite ions.

12. In the above description 11, the alternating voltage for resonant excitation is superimposed on voltages at a plurality of frequencies with which ions resonate to excite ions with all of mass-to-charge ratios.

13. In the above description 11, the alternating voltage for resonant excitation is allowed to change in an amplitude thereof in units of frequencies, and energy to be given to ions with individual mass-to-charge ratios is allowed to be individually set.

14. In the above description 13, an amplitude is controlled for individual frequencies so that ions with a first mass-to-charge ratio have a velocity the same as that of ions with a mass-to-charge ratio lower than the first mass-to-charge ratio.

### DESCRIPTION OF REFERENCE NUMERALS AND SIGNS

1 Ion source
2 Aperture
3 Aperture
5 Differential pumping unit
6 Analyzing unit
7 Quadrupole mass filtering unit
8 Detector
9 Ion trapping unit
10 Quadrupole rod electrode
11 Quadrupole electrostatic electrode
11 Center axis of the quadrupole mass filter
23 Vane electrode
24 Trap wire electrode
25 Lead wire electrode
27 Inlet end electrode
28 Outlet end electrode
30 Offset voltage power supply
31 Quadrupole electrostatic voltage power supply
32 Auxiliary alternating voltage power supply
50 Triple quadrupole unit
51 Collision induced dissociation electrode
52 Vane electrode
53 Outlet end electrode
60 Stable region
61 Stable region of the ions with a small m/z
62 Stable region of the ions with a medium m/z
63 Stable region of the ions with a large m/z
64 Transition when ions enter the quadrupole mass filter
65 Transition when ions enter the quadrupole mass filter with a Brubaker lens
66 Transition when ions enter the quadrupole mass filter
71 Quadrupole electrostatic voltage
72 Offset voltage
73 Scan line for the quadrupole RF voltage and the quadrupole electrostatic voltage
80 Range of the q-value of ions in the stable region when the quadrupole electrostatic voltage is zero
80 Range of the q-value of ions in the stable region when the a-value is a1
90 Mass range of the ions ejected from the quadrupole mass filtering unit
91 Mass range of the ions ejected from the quadrupole mass filtering unit for a certain time period
92 m/z of the ions ejected from the ion trapping unit
93 Time period for trapping ions with a mass m1 in the trap
99 Trajectory of ions to be ejected
100 Region in which ions are trapped
101 Ion source
102, 110 Aperture
103 First stage quadrupole
104 Inlet aperture
105 Collision cell
106 Second stage quadrupole
107 First stage vane electrode pair
107a Front vane electrode
107b Rear vane electrode
108 Second stage vane electrode pair
109 Third stage vane electrode pair
111 Mass separating unit (quadrupole mass spectrometer)
112 Third stage quadrupole
113, 505 Detector
201 First stage quadrupole direct/alternating power supply
202 Second stage quadrupole direct/alternating power supply
203 First stage vane electrode pair direct current power supply
204 Second stage vane electrode pair direct current power supply
205 Third stage vane electrode pair direct current power supply
206 Vane electrode pair alternating power supply
207 Third stage quadrupole direct/alternating power supply
210 First stage quadrupole direct current voltage potential
211 Second stage quadrupole direct current voltage potential
212 Potential difference for collision induced dissociation
213 Harmonic potential formed by the first stage vane electrode pair
501 Range from the ion source to the aperture shown in FIG. 19
502 Mass separating unit (time-of-flight mass spectrometer)
503 Accelerating electrode
504 Reflecting electrode

1. A mass spectrometer comprising:
an ion source configured to generate ions;
an ion transport unit configured to transport the ions;
an ion separating unit configured to separate ions in a specific mass range; and
a detecting unit configured to detect the ions separated in the ion separating unit,
wherein the ion separating unit includes:
quadrupole rod electrodes configured to form a quadrupole radio-frequency electric field;
electrodes each inserted between the quadrupole rod electrodes, the electrodes being configured to form a quadrupole electrostatic field; and
a voltage control unit configured to control at least a voltage of the electrodes to form a quadrupole electrostatic field.

2. The mass spectrometer according to claim 1, wherein an electric potential gradient is formed on a center axis of the quadrupole rod electrodes by the electrodes to form a quadrupole electrostatic field.

3. The mass spectrometer according to claim 1, wherein a strength of a quadrupole electrostatic field to be applied by the voltage control unit is small on an inlet side of the mass spectrometer and large on an exit side thereof.

4. The mass spectrometer according to claim 1, comprising an electrode configured to vibrate ions in a radial direction of the ion separating unit, and a power supply.

5. The mass spectrometer according to claim 1, wherein the electrodes to form a quadrupole electrostatic field are a plate shaped electrode or rod shaped electrode inserted between the quadrupole rod electrodes.

6. The mass spectrometer according to claim 5, wherein a distance between the electrodes to form a quadrupole electrostatic field and a center of quadrupole is greater on an inlet side of ions than that on an exit side.

7. The mass spectrometer according to claim 6, wherein the electrodes to form a quadrupole electrostatic field have a shape in which a distance from a center of the quadrupole is increased by a square of a distance from an ion exit of the ion separating unit.

8. The mass spectrometer according to claim 1, wherein for the electrodes to form a quadrupole electrostatic field, opposing electrodes thereof are applied with an electrostatic voltage of a same polarity, and adjacent electrodes thereof are applied with an electrostatic voltage of a reverse polarity by the voltage control unit.

9. The mass spectrometer according to claim 5, wherein, the quadrupole electrostatic electrode is applied with an offset voltage of a reverse polarity of the ions introduced into the ion separating unit by the voltage control unit.

10. The mass spectrometer according to claim 1, wherein the electrodes to form a quadrupole electrostatic field are formed on an inner side than an end of the quadrupole rod electrodes.

11. The mass spectrometer according to claim 10, wherein the quadrupole electrostatic electrode is applied with an offset voltage of a same polarity of that of the ions introduced into the ion separating unit by the voltage control unit.

12. The mass spectrometer according to claim 1, wherein:
the ion separating unit includes an ion trap electrode on an outer side of the quadrupole rod electrodes, the ion trap electrode being configured to trap ions in the ion separating unit; and
the voltage control unit applies, to the electrodes to form a quadrupole electrostatic field, a voltage of an amplitude to stabilize only ions in a specific mass range, for the trapped ions.

13. The mass spectrometer according to claim 1, further comprising:
an ion dissociating unit configured to dissociate ions; and
a second ion separating unit different from the ion separating unit.

14. The mass spectrometer according to claim 13, wherein the ion separating unit, the ion dissociating unit, and the second ion separating unit are formed in such order that electrostatic potentials are decreased on a center axis of common quadrupole rod electrodes as ions travel.

15. The mass spectrometer according to claim 1, wherein a second separating unit different from the ion separating unit is included between the ion separating unit and the detecting unit.

16. The mass spectrometer according to claim 15, wherein the second separating unit is a separating unit including a quadrupole rod electrode and an exit side end electrode.

17. The mass spectrometer according to claim 1, wherein the electrodes to form a quadrupole electrostatic field are formed of a resistive element.

18. The mass spectrometer according to claim 1, wherein the electrodes to form a quadrupole electrostatic field are an electrode split in an axial direction.

19. A mass spectrometer comprising:
an ion source unit configured to ionize a sample;
a first mass separating unit configured to select target ions from the ions generated in the ion source;
a collision cell configured to perform collision induced dissociation for the selected ions;
a second mass separating unit configured to select fragment ions produced by collision induced dissociation to again mass separation; and
a detector configured to detect ions,
wherein a harmonic potential is formed in an inside of the collision cell, the fragment ions produced by collision induced dissociation are resonance excited in the inside of the collision cell, and energy is given to the ions in an axial direction.

20. The mass spectrometer according to claim 19, wherein the collision cell traps ions in which a high frequency voltage is applied to a multipole such as a quadrupole or octopole for forming a quasi well potential in a perpendicular direction with respect to a traveling direction of the ions.

21. The mass spectrometer according to claim 19, wherein a harmonic potential to be formed in the inside of the collision cell is formed in an axial direction in which a flat plate shaped electrode is arranged and a direct current voltage is applied thereto.

22. The mass spectrometer according to claim 19, wherein an alternating voltage is superimposed on a harmonic potential to excite the ions.

23. The mass spectrometer according to claim 22, wherein the alternating voltage for resonant excitation is superimposed on voltages at a plurality of frequencies with which ions are resonance excited to excite ions with all of mass-to-charge ratios.

24. The mass spectrometer according to claim 23, wherein:
the alternating voltage for resonant excitation is allowed to change in an amplitude thereof in units of frequencies; and
energy to be given to ions with individual mass-to-charge ratios is allowed to be individually set.

25. The mass spectrometer according to claim 24, wherein an amplitude is controlled for individual frequencies so that ions with a first mass-to-charge ratio have a velocity the same as that of ions with a mass-to-charge ratio lower than the first mass-to-charge ratio.

26. A mass spectrometry method comprising:
ionizing a sample;
selecting target ions from generated ions;
performing collision induced dissociation for the selected ions;
selecting fragment ions produced by collision induced dissociation to again mass separation; and
detecting ions,
wherein the produced fragment ions are resonance excited by a harmonic potential, and energy is give to the ions in an axial direction.

27. The mass spectrometry method according to claim 26, wherein if collision induced dissociation is performed for the selected ions, ions are trapped in which a high frequency voltage is applied to a multipole to form a quasi well potential in a perpendicular direction with respect to a traveling direction of the ions.

28. The mass spectrometry method according to claim 26, wherein the harmonic potential is formed in the axial direction by applying a direct current voltage to a flat plate shaped electrode.

29. The mass spectrometry method according to claim 26, wherein an alternating voltage is superimposed on the harmonic potential to resonance excite ions.

30. The mass spectrometry method according to claim 29, wherein the alternating voltage for resonant excitation is superimposed on voltages at a plurality of frequencies with which ions resonate to excite ions with all of mass-to-charge ratios.

31. The mass spectrometry method according to claim 30, wherein:
the alternating voltage for resonant excitation is allowed to change in an amplitude thereof in units of frequencies; and
energy to be given to ions with individual mass-to-charge ratios is allowed to be individually set.

32. The mass spectrometry method according to claim 31, wherein an amplitude is controlled for individual frequencies so that ions with a first mass-to-charge ratio have a velocity the same as that of ions with a mass-to-charge ratio lower than the first mass-to-charge ratio.
